(19) United States
(12) Patent Application Publication
(10) Pub. No.: US 2002/0082083 A1
(43) Pub. Date: Jun. 27, 2002

(54) INFORMATION COMMUNICATION ELECTRONIC DEVICE AND INFORMATION DISPLAY METHOD

(76) Inventors: TAKESHI ITO, TOKYO (JP); EIJI KAWAI, KANAGAWA (JP); MASAHARU YOSHIMORI, TOKYO (JP)

Correspondence Address: KATTEN MUCHIN ZAVIS ROSENMAN, 575 MADISON AVENUE, NEW YORK, NY, 10022-2585, US

(21) Appl. No.: 09/431,903

(22) Filed: Nov. 2, 1999

(30) Foreign Application Priority Data
Nov. 2, 1998 (JP) P10-312407

(51) Int. Cl. G06F 19/00

(52) U.S. Cl. 463/41

(57) ABSTRACT

An information communication electronic device such as a portable game machine and a method having a display unit which displays a change in a content of information when the electronic device is moved by a user. The electronic device also has a movement detection unit and a control unit. When a movement is made in a predetermined direction by dX in the horizontal direction and dY in the vertical direction, the portable game machine causes the representative point for main image data to move in that predetermined direction and without changing the movement-system coordinates on the display unit the control unit changes its absolute coordinates by (+dX,+dY) and displays the change on the display unit. The display unit has a pointer and the device causes its representative point to move in the opposite direction, and without changing its absolute coordinates, the control unit changes its movement-system coordinates by −dX in the horizontal direction and −dY in the vertical direction and displays it on the display unit

### BACKGROUND OF THE INVENTION

1. Field of the Invention

This invention relates to an information communication electronic device that is suitable for a small portable terminal such as a portable information communication terminal, and an information display method using that electronic device.

2. Description of the Prior Art

Small portable terminals, such as portable information communication terminals, small portable game machines, and portable telephones, have come into wide use because they are so easy to carry around. The small portable terminals operate independently on their own but also have telephone functions and the function of executing programs for doing various data processing. For example, a personal computer or a home console of a video game machine may serve as the parent machine while a small portable terminal connected to it serves as an auxiliary calculation or memory resource or is used as a communication means when communicating with external equipment.

Many conventional small portable terminals have a high-precision liquid crystal display as their display unit. When such a small portable terminal is used as an input device, for example a pen or stylus (referred to as pen, hereinafter) is generally used, and various information can be input by pressing the pen directly against the liquid crystal display.

However, in a conventional small portable terminal, the pen is not unitized with the device itself, and when using it one must take the trouble of getting out the pen, plus there is the problem that both hands are occupied, using one hand to hold the device and the other hand to hold the pen. Also, one can sometimes loose the pen.

Moreover, in a conventional small portable terminal, it is possible to perform the input not with a pen but by connecting, for example, a keyboard or a mouse to the terminal. However, then one may have the problem of lack of portability.

### SUMMARY OF THE INVENTION

It is an object of the present invention, which was devised in consideration of the aforementioned problems, to provide an information communication electronic device that is suitable for a small portable terminal such as a portable information communication terminal, and an information display method using the electronic device.

This and other objects of the present invention are attained by an information communication electronic device comprising at least a display means that displays main information; a movement detection means that detects a direction and a distance of any movement of the information communication electronic device from a first position to a second position; and a control means that changes the content of what is displayed on said display means in accordance with said detected movement.

In the information communication electronic device of this invention, the content of what is displayed on the display means is changed and displayed in accordance with said movement.

The objects of the present invention are also attained by an information display method of this invention comprising the steps of at least displaying main information on a display means; detecting a direction and distance of any movement of the display means from a first position to a second position; and changing the content of what is displayed on said display means in accordance with the detected movement.

In the information display method of the present invention configured as described above, the content of what is displayed on the display means is changed and displayed in accordance with said movement.

### BRIEF DESCRIPTION OF THE DRAWINGS

FIG. 1 is a front view of a portable game machine according to an embodiment of the present invention;

FIG. 2 is a side view of the portable game machine of FIG. 1;

FIG. 3 is a block diagram showing the configuration of the hardware layers of the portable game machine of FIGS. 1 and 2;

FIG. 4 is a diagram for explaining how the portable game machine changes the position of a displaying pointer in accordance with a movement of the portable game machine showing the state before the movement;

FIG. 5 is a diagram for explaining how the portable game machine changes the position of the displaying pointer in accordance with a movement of the portable game machine, showing the state after the movement;

FIG. 6 is a diagram for explaining how the portable game machine changes and displays a region of map data in accordance with a movement, showing the state before the movement according to another embodiment; and

FIG. 7 is a diagram for explaining how the portable game machine changes and displays a region of map data in accordance with a movement, showing the state after the movement according to the embodiment of FIG. 6.

### DETAILED DESCRIPTION OF THE PREFERRED EMBODIMENTS

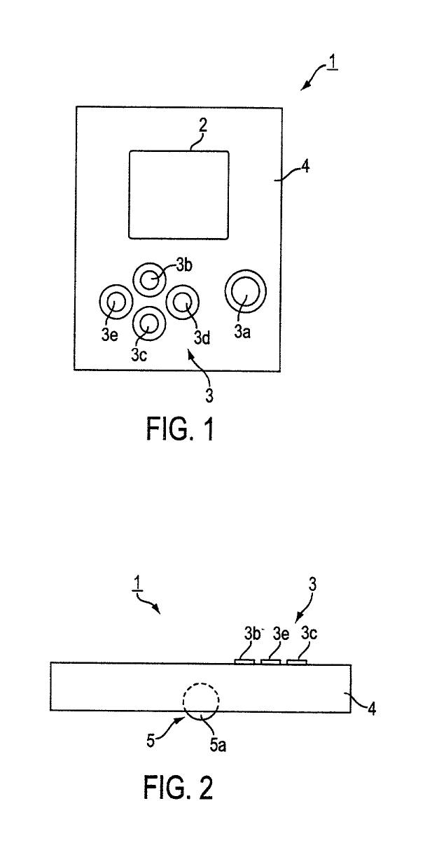

A portable game machine 1 shown in FIG. 1 as an embodiment of this invention is configured, for example, as a portable information communication terminal (personal digital assistant, or PDA) that can send data to and receive data from external devices via a wireless communication function and can execute various application software. The portable game machine 1, which has the appearance shown in FIG. 1, has a display unit 2, which is a display means, and an operation unit 3, and these units are accommodated in a housing 4.

The display unit 2 consists of, for example, a reflective liquid crystal panel, and displays on this reflective liquid crystal panel various text information or image information, etc.

The operation unit 3 includes one or more operation buttons 3a through 3e and performs an event input, a various selection, etc.

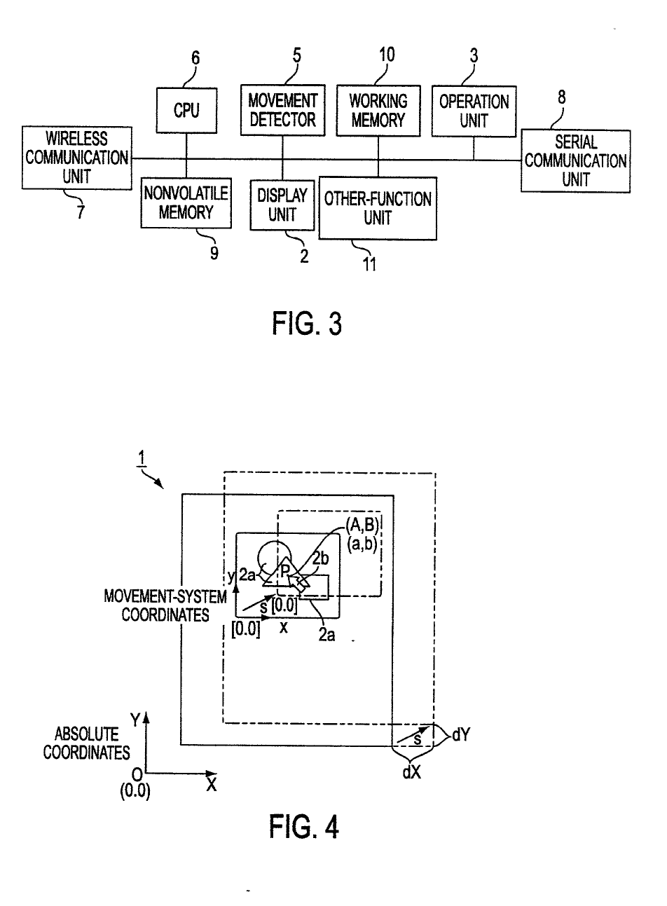

As shown in FIG. 2, portable game machine 1 has a mouse ball or track ball (hereafter called “mouse ball”) 5a. The mouse ball 5a, which is one element of a movement detector 5, which is the movement detection means shown in FIG. 3, is an input unit for movement detection. As shown for example in FIG. 2, the movement detector 5 is constructed in such a way that mouse ball 5a is embedded in housing 4 positioned approximately in the middle of the rear surface of portable game machine 1, with its tip region exposed to the outside, and multiple rollers provided inside housing 4 which are not shown rotate in linkage with the movement of the mouse ball 5a. The movement detector 5 detects the direction and distance in which the portable game machine 1 is moved by detecting, by a circuit unit not shown, the rotation of rollers not shown that arises by virtue of the fact that the portable game machine 1 itself is placed, for example, on a flat surface, and mouse ball 5a moves while in contact with the flat surface.

As shown in FIG. 3, the portable game machine 1 includes of a layer of hardware which has, besides the display unit 2, operation unit 3, and movement detector 5, a CPU 6, which is a control means, a wireless communication unit 7, a serial communication unit 8, a nonvolatile memory 9, a working memory 10 and another-function unit 11.

The wireless communication unit 7 has functions for a wireless communication with external devices. The wireless communication unit 7 transmits data to and receives data from external devices by means of, for example, IrDA (Infrared Data Association), etc. infrared rays or microwaves, etc.

The serial communication unit 8 has functions of performing serial communication with external devices. The serial communication unit 8 may, for example, be electrically connectable with external devices, thereby performing data communication processing with those external devices.

The nonvolatile memory 9 is a memory unit that stores various data. Stored in the nonvolatile memory 9 are, for example, game programs and other application software, and various data acquired by communication with external devices.

The working memory 10 is a memory unit that is used as a working region for various data. Stored in this working memory 10 are, for example, game programs and other application software, and various data acquired by communication with external devices in the same way as with the nonvolatile memory 9.

The other-function unit 11 includes various parts other than those described above; for example, it may include a power source, which is not shown.

The CPU 6 has the function of controlling the above-described parts in accordance with, for example, various programs. It also has the function of changing the content of the image data displayed on display unit 2 in accordance with the results of detection by motion detector 5.

The portable game machine 1 having the above-described configuration is able to independently execute various application software such as game programs. And when portable game machine 1 is connected with, for example, an external device that serves as the parent machine, it may be constructed so as to function as the mouse of such external device, and can play a role as an input means of the external device.

Next, the content displayed on display unit 2 when portable game machine 1 is placed on a flat surface and the mouse ball is moved while in contact with the flat surface will be described. Here, as shown in FIG. 4, two-dimensional coordinates are used which are fixed on the plane in which a point O on the plane is taken as the origin, the horizontal axis is X, and the vertical axis is Y, and two-dimensional coordinates whose origin is the lower left of display unit 2, the horizontal axis is x, and the vertical axis is y, and which moves along with the movement of the portable game machine 1. In the description, the former coordinates are called the absolute coordinates, and the latter are called the movement-system coordinates.

In portable game machine 1, a pointer 2b, which is a marker for pointing at information within display unit 2, is displayed on display unit 2 together with main image data 2a, such as a picture or text, which is the main information. Here, in the subsequent description, the approximate midsection of main image data 2a is taken as the representative point of main image data 2a, and the tip of pointer 2b is taken as its representative point. That is, the representative point of main image data 2a and pointer 2b in their initial position is taken to be point P of absolute coordinates (A,B) (movement-system coordinates [a,b]).

Also, when expressing coordinates, a distinction is made between absolute coordinates (X,Y) and movement-system coordinates [x,y].

When portable game machine 1 is moved from its initial position while being kept in contact with the flat surface, movement detector 5 detects the direction and distance of its movement, and in accordance with this, pointer 2b is moved within display unit 2 by CPU 6. Here, in the same diagram, portable game machine 1 is moved in the direction indicated by arrow s, which is dX in the horizontal direction and dY in the vertical direction.

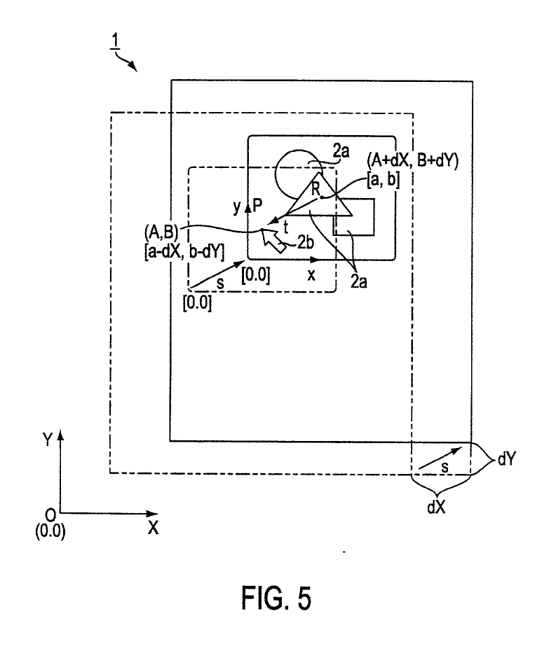

In the portable game machine 1, shown in FIG. 5, with regard to what is displayed on display unit 2, there is no change, before and after the movement, for main image data 2a, but the position of pointer 2b does change.

Expressing this in terms of coordinates X and Y, in the portable game machine 1, the representative point of main image data 2a displayed on display unit 2 moves in the direction of arrow s, and its absolute coordinates are expressed by the coordinates (A+dX,B+dY) of point R, which is moved just (+dX,+dY) from point P of (A,B). The movement-system coordinates remain unchanged before and after the movement, remaining at [a,b].

Meanwhile, the absolute coordinates of the representative point of pointer 2b remain unchanged before and after the movement remaining at (A,B), but the movement-system coordinates are expressed by [a−dx,b−dY]. That is, the representative point of pointer 2b moves in the direction of arrow t, and its movement-system coordinates are expressed by the values in which there is a movement of −dX in the horizontal direction and −dY in the vertical direction.

That is, in portable game machine 1, CPU 6 moves and displays pointer 2b within display unit 2, moved the same distance and in exactly the opposite direction from the direction of movement detected by movement detector 5. Therefore as portable game machine 1 moves, the user sees the main image data 2a move while the position of pointer 2b remains always fixed and unchanging.

Thus in the portable game machine 1, the content displayed on display unit 2 can be pointed to by pointer 2b by having the user move the portable game machine 1. For example, when the function keys, etc. are displayed, by moving the device itself and causing pointer 2b to move to the displayed position, it is possible to position pointer 2b to the desired position and make a selection by input with the operation unit 3 Therefore in the portable game machine 1 it is possible to do pointing at main image data 2a displayed on display unit 2 by the same operation method as with a mouse, operating it with one hand with no loss of portability, and requiring no pen or similar input device.

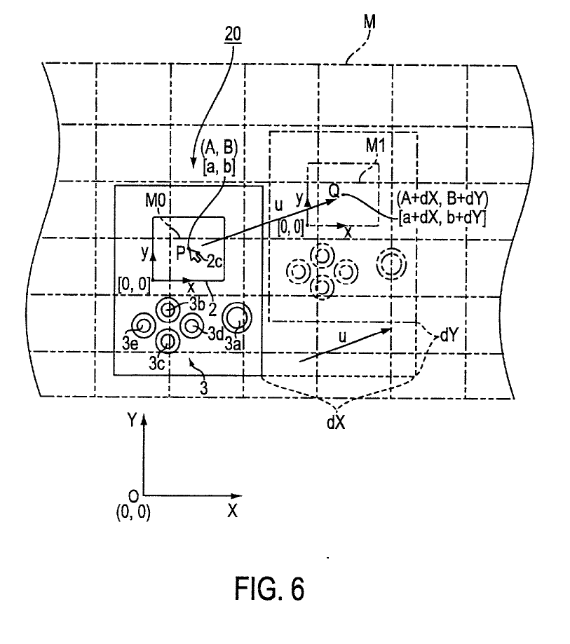

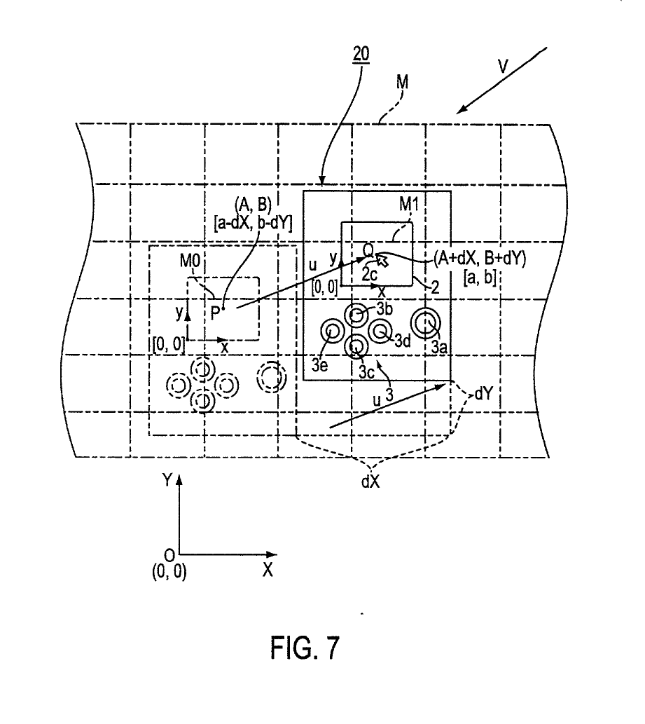

Next, further embodiments of the above portable game machine will be described, referring to FIGS. 6 and 7.

A portable game machine 20 shown in FIGS. 6 and 7 as the second embodiment has its basic structure similar to that of portable game machine 1 shown in FIGS. 1 through 3, and that movement is made within the display unit by applying to the main image data the technique in which movement is made to the same distance but in the direction exactly opposite to the direction of movement detected by the movement detector. For the configuration that is the same as that of portable game machine 1 shown in FIGS. 1 through 3 above, the same reference numerals are used, and a detailed description is omitted.

The portable game machine 20 reads the image data stored in a memory such as nonvolatile memory 9, displays it on display unit 2, and changes the displayed content by means of CPU 6 in accordance with the results detected by movement detector 5.

The case in which map data M is displayed as the main image data on display unit 2, as shown in FIG. 6 will be now described. The map data M is pre-stored in a memory of portable game machine 20, such as nonvolatile memory 9. Here map data M consists of a collection of multiple regions, each of an area that can be displayed all at once on display unit 2, and it corresponds to their wide-area connected region. As shown in the diagram, map data M is explained as having a virtual spatial extent. Also, one lattice of this map data M shows the standard for the size that can be displayed all at once on display unit 2.

In the following description, as in the aforesaid first embodiment, are used two-dimensional coordinates fixed on the plane in which a point O on the plane is taken as the origin, the horizontal axis is X, and the vertical axis is Y, and two-dimensional coordinates whose origin is the lower left of display unit 2, the horizontal axis is x, and the vertical axis is y, and which moves along with the movement of portable game machine 20. In the description, the former coordinates are called the absolute coordinates, and the latter are called the movement-system coordinates. Also, as explained in the first embodiment, a distinction is made between absolute coordinates (X,Y) and movement-system coordinates [x,y].

In the portable game machine 20, assume as the initial position that a region including point P (absolute coordinates (A,B), movement-system coordinates [a,b]) in region M0 within map data M is displayed in the middle of display unit 2. Also assume that in display unit 2, a fixed pointer 2c is displayed, and its tip always points at the middle of display unit 2. That is, in the initial position, pointer 2c is displayed with its tip matching point P. Here the case is described in which the user, in order to find a desired point Q (absolute coordinates (A+dX,B+dY), movement-system coordinates [a+dX,b+dY]) within region M1, moves the portable game machine 20 in the direction of arrow u, by dX in the horizontal direction and dY in the vertical direction.

In the portable game machine 20, as shown in FIG. 7, when the region displayed on display unit 2 is moved from the vicinity of M0 to the vicinity of M1 by CPU 6 in accordance with the results detected by movement detector 5, and point Q is positioned in the middle of display unit 2, then pointer 2c is displayed by CPU 6, on display unit 2 without changing its position within display unit 2. That is, in portable game machine 20, pointer 2c, which is displayed on display unit 2 by CPU 6, moves in the direction of arrow u as portable game machine 20 moves, and its absolute coordinates are expressed by coordinates (A+dX,B+dY), in which it moves from (A,B) by (+dX,+dY). Also, because pointer 2c is displayed fixed in the center of display unit 2, the movement-system coordinates of its representative point remain unchanged at [a,b] before and after the movement.

Meanwhile, with regard to map data M, when it moves from point P of absolute coordinates (AB) to point Q of (A+dX,B+dY), its movement-system coordinates are expressed as [a−dX,b−dY] or point P and [a,b] for point Q. That is, map data M moves in the direction of arrow v, and its movement-system coordinates are expressed by the values moved by −dX in the horizontal direction and by −dY in the vertical direction.

That is, the portable game machine 20, by means of CPU 6, moves, and displays within display unit 2, map data M in the direction and by the distance moved that are expressed by arrow v, which is in exactly the opposite direction of movement expressed by arrow u detected by movement detector 5. Therefore, in the portable game machine 20, by having the user make movements directly, one can use portable game machine 20 in the sense that if pointer 2c is moving across an actually spread-out map, one can display the desired region on display unit 2. Also, in portable game machine 20, there is no need for a pen or any other input device, and one can operate it with one hand by the same operation method as a mouse, without loss of portability.

In the above-described first embodiment and second embodiment, by means of the functions of CPU 6, the calculation of the amount of movement concerning the absolute coordinate system and the movement coordinate system differs, and the image data to be displayed in display unit 2 differs. It is possible, as desired, to arbitrarily set, by means of operation unit 3, whether to adopt either the first embodiment or the second embodiment. Also, one can, by means of operation unit 3, switch between the first embodiment and the second embodiment as desired.

As has been explained above, in a portable game machine shown as an embodiment of this invention, there is no need for an input device such as a pen, and one can perform pointing to the information displayed on the display means by the same operation means as a mouse and can display the desired information. Therefore in the portable game machine one can perform operations with one hand, with no loss in portability.

Also, the embodiments of the present invention are not limited to the above-described compositions, and the explanation given was for a composition in which a mouse ball is used as a movement detection means, but one may also detect movement by a method using, for example, light, radio waves, or magnetism, as long as one is able to detect the direction and distance of the movement. In addition, the object to be moved within the display means is not limited to pointers or map data but can, needless to say, include various objects as desired.

As described in detail above, the information communication electronic device of the present invention comprises at least a display means that displays the main information, a movement detection means that detects the direction and distance when a movement of the electronic device is made from a first position to a second position, and a control means that changes the content that is displayed on the display means in accordance with that movement.

In this way, in the information communication electronic device of this invention, by changing and displaying the content that is displayed on the display means, one can, with good portability and operability, give instruction information and display the desired information displayed on the display means.

Also, the information display method of this invention comprises the steps of at least displaying main information on the display means, detecting the direction and distance of movement when there is a movement of the display means from a first position to a second position, and changing the content that is displayed on the display means in accordance with the detected movement.

In this way, with the information display method of this invention, by changing and displaying the content that is displayed on the display means, one can, by a simple operation, give instruction information and display the desired information displayed on the display means.

What is claimed is:

1. An information communication electronic device comprising:
a display means that displays main information,
a movement detection means that detects a direction and a distance of a movement of the information communication electronic device when the movement is made from a first position to a second position; and
a control means that changes a content displayed on said display means in accordance with a detected movement.

2. The information communication electronic device as described in claim 1, wherein said control means moves a marking information, which is displayed for indicating said main information, in a direction opposite to the direction of movement detected by said movement detection means and for the same distance as said detection movement, and displays said moved marking information on said display means.

3. The information communication electronic device as described in claim 1, wherein said control means moves said main information in the opposite direction and for the same distance as the direction of movement detected by said movement detection means, and displays said moved main information on said display means.

4. An information display means comprising the steps of:
at least displaying main information on a display means of an electronic device,
detecting a direction and distance of a movement of the electronic device when the movement is made from a first position to a second position; and
changing a content displayed on said display means in accordance with the detected movement.

5. The information display method as described in claim 4, wherein
the said main information and a marker for indicating said main information are displayed on said display means; and
said marker is moved in the opposite direction and for the same distance as the detected direction of movement and is displayed on said display means.

6. The information display method as described in claim 4, wherein
said main information is moved in the opposite direction and for the same distance as the detected direction of movement and is displayed on said display means.
